(19) United States
(12) Patent Application Publication
(10) Pub. No.: US 2007/0212541 A1
(43) Pub. Date: Sep. 13, 2007

(54) Core/shell type particle phosphor

(76) Inventors: Kazuya Tsukada, Sagamihara-shi (JP); Kazuyoshi Goan, Sagamihara-shi (JP); Naoko Furusawa, Tokyo (JP); Hisatake Okada, Tokyo (JP); Hideki Hoshino, Tokyo (JP)

Correspondence Address: CANTOR COLBURN, LLP, 55 GRIFFIN ROAD SOUTH, BLOOMFIELD, CT, 06002, US

(21) Appl. No.: 11/712,665

(22) Filed: Mar. 1, 2007

(30) Foreign Application Priority Data
Mar. 7, 2006 (JP) JP2006-060752

(51) Int. Cl. C09K 11/08

(52) U.S. Cl. 428/403; 252/301.4 R; 252/301.4 P; 252/301.4 F; 252/301.4 S; 252/301.4 H; 252/301.5; 252/301.6 R; 252/301.6 P; 252/301.6 S; 252/301.6 F; 977/834; 977/773

(57) ABSTRACT

An objective is to provide a core/shell type particle phosphor exhibiting an optimal excitation wavelength for fluorescence observation and excellent emission luminance of PL, together with excellent durability, to which particles are produced so as to be suitable for the field of bio-nanotechnology. Disclosed is a core/shell type particle phosphor comprising a core particle phosphor and coated thereon, a shell made of a metal compound having a different composition from a composition constituting the core particle phosphor, wherein the core particle phosphor is a particle phosphor prepared by baking a precursor synthesized via a reactive crystallization method, satisfying a PL (photoluminescence) intensity ratio A of the core particle phosphor to the core/shell type particle phosphor, {PL intensity(core)/PL intensity(core/shell)}; 0.001≦A≦0.1, and a core/shell type particle diameter of at most 0.1 μm.

This application claims priority from Japanese Patent Application No. 2006-060752 filed on Mar. 7, 2006, which is incorporated hereinto by reference.

### TECHNICAL FIELD

The present invention relates to a core/shell type particle phosphor utilized for a display specifically in the field of bio-nanotechnology.

### BACKGROUND

In recent years, attention has currently been focused on nanostructure-crystals of a II-VI semiconductor relating to porous silicon and ultrafine particles made of silicon or germanium, which exhibit unique optical properties. The nanostructure-crystals described here mean crystalline grains having a grain diameter of a few nanometers, and are commonly called nanocrystals.

When the case of the above-described nanostructure-crystals is compared with the case of bulk crystals, the nanostructure-crystals exhibit higher optical absorption and luminescence properties than those of the bulk crystals. It is assumed that the nanostructure-crystals produce a wider band gap than that of the bulk crystals, since a II-VI semiconductor having nanostructure-crystals generates the quantum size effect. In other words, it may be considered that a II-VI semiconductor having nanostructure-crystals broadens a band gap via the quantum size effect.

Incidentally, various phosphors are utilized in displays employed for TV and so forth.

The particle diameter of a phosphor utilized in displays employed for TV and so forth is roughly 3-10 μm, and in recent years, attention is also focused on various displays such as plasma display (PDP), field-emission display (FED), electroluminescence display (ELD) and surface-conduction electron-emitter display (SED) which have been developed specifically in view of thin-model TVs.

In the case of FED among the above-described displays, an electron beam voltage is desired to be lowered when producing a thinner-model.

However, in the case of a thinner-model display, no luminescence is sufficiently produced because of low electron beam voltage, when a phosphor particle diameter of roughly 3-10 μm as described above is employed.

That is, the conventional phosphor can not be sufficiently excited in the case of employing such the thin-model display. An irradiated electron beam can not reach the luminous portion of a luminous body, because conventional phosphor crystals are large in size. Accordingly, in the case of utilizing the conventional phosphor having a phosphor diameter of roughly 3-10 μm for a thin-model display, no luminescence was sufficiently produced. Therefore, it can be said that a phosphor capable of exciting at low voltage is suitable for the thin-model display, specifically for FED. The II-VI semiconductor having the foregoing nanostructure-crystals can be provided as a phosphor satisfying such the conditions.

However, there is a problem such that insufficient luminance and luminance unevenness are generated because of a luminescence killer caused by a defective size distribution via coagulation and a plurality of defects on the crystalline surface as to nanostructure-crystals which have been studied so far (refer to Patent Documents 1-4). Further in the field of biotechnology, a fluorescent material made of organic matter molecules has been utilized as a label for studies of virus and enzyme or a clinical laboratory test, and disclosed is a method in which fluorescence generated via UV exposure is measured by an optical microscopy or a photodetector. An antigen-antibody fluorescence method and the like, for example, are commonly known as such the method.

An antigen to which a fluorescence-generating organic phosphor is bound (referred to as a specific binding material) is used in this method. An antigen position can be found out via a fluorescence intensity distribution, since the antigen-antibody reaction has a very high selectivity.

Meanwhile, in this field, an antibody having a size of less than approximately 1 μm is strongly desired to be observed to do research on the antibody distribution more precisely. Accordingly, it is to be undeniable to rely on an electron microscope in order to realize this.

As for electron microscopic observation, images are observed by utilizing a difference between an electron beam reflectivity of a specimen and an electron beam transmittance of the specimen. Therefore, in the case of observing an antibody employing an electron microscope, a molecule containing iron or osmium having a large atomic weight, or gold colloid having a size of roughly 1-100 nm is currently utilized as an antibody label. In the case of employing the gold colloid as a label, for example, a complex of protein A and gold colloid is combined with an antibody. A localized site of an antibody can be revealed by measuring a gold colloid position on a specimen, since this antibody is combined with the corresponding antigen via the antigen-antibody reaction. Further, a plurality of antibodies are possible to be simultaneously observed when at least two kinds of gold colloid in different sizes are combined with a plurality of antibodies. However, there is still a problem in this method such that it takes more than the measured number of colloid to determine quantitatively, since the colloid tends to be overlapped with each other during measurement.

It is also difficult to observe cathodoluminescence images by employing the above-described phosphor as a label. That is, luminescence of the organic phosphor is largely reduced by scanning only once to be off from practical use, since the organic phosphor has low luminus efficiency originally, and further, the luminus efficiency is lowered by easily breaking a dye molecular bond via electron beam exposure.

This organic phosphor exhibits instability during storage, and is also degraded. Further, as a phosphor made of organic matter molecules, known is a polystyrene sphere having a particle diameter of several tens of nanometer, and producing red, green or blue luminescence in addition to a molecular organic phosphor dye, but exactly the same problem as described above has been produced.

Compared with this, an inorganic phosphor exhibits stability caused upon exposure to UV and electron beam, and is not comparatively deteriorated. However, the phosphor made practicable for TVs or lamps usually has a size of at least 1 μm, whereby it is not usable as-is as a phosphor for the antigen-antibody reaction. In order to reduce the particle size, the phosphor should be subjected to a pulverizing treatment or a etching treatment with an acid, but in this method, a ratio of the area occupied by a nonluminescent layer covering the surface of each particle becomes larger, whereby the luminus efficiency drops largely.

(Patent Document 1) Japanese Patent O.P.I. Publication No. 2002-322468

(Patent Document 2) Japanese Patent O.P.I. Publication No. 2005-239775

(Patent Document 3) Japanese Patent O.P.I. Publication No. 10-310770

(Patent Document 4) Japanese Patent O.P.I. Publication No. 2000-104058

### SUMMARY

The present invention was made on the basis of the above-described situation. It is an object of the present invention to provide a core/shell type particle phosphor exhibiting an optimal excitation wavelength for fluorescence observation and excellent emission luminance of PL (photoluminescence) together with excellent durability, to which particles are produced so as to be suitable for the field of bio-nanotechnology. Disclosed is a core/shell type particle phosphor comprising a core particle phosphor and coated thereon, a shell made of a metal compound having a different composition from a composition constituting the core particle phosphor, wherein the core particle phosphor is a particle phosphor prepared by baking a precursor synthesized via a reactive crystallization method, satisfying a PL (photoluminescence) intensity ratio A of the core particle phosphor to the core/shell type particle phosphor, {PL intensity(core)/PL intensity(core/shell)}, 0.001≦A≦0.1, and a core/shell type particle diameter of at most 0.1

### BRIEF DESCRIPTION OF THE DRAWINGS

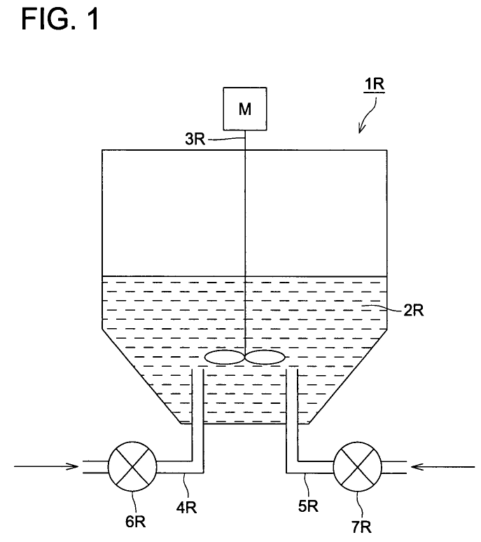

Embodiments will now be described, by way of example only, with reference to the accompanying drawings which are meant to be exemplary, not limiting, and wherein like elements numbered alike in several figures, in which: FIG. 1 shows a schematic diagram of a double jet reactive crystallization apparatus.

### DESCRIPTION OF THE PREFERRED EMBODIMENTS

The above object of the present invention is accomplished by the following structures.

(Structure 1) A core/shell type particle phosphor comprising a core particle phosphor and coated thereon, a shell made of a metal compound having a different composition from a composition constituting the core particle phosphor, wherein the core particle phosphor is a particle phosphor prepared by baking a precursor synthesized via a reactive crystallization method, satisfying a PL (photoluminescence) intensity ratio A of the core particle phosphor to the core/shell type particle phosphor, {PL intensity(core)/PL intensity(core/shell)}; 0.001≦A≦0.1, and a core/shell type particle diameter of and at most 0.1 μm.

(Structure 2) The core/shell type particle phosphor of Structure 1, wherein a value of B/A is 10-100, provided that a CL (cathodeluminescence) intensity ratio of the core particle phosphor to the core/shell type particle phosphor, {CL intensity(core)/CL intensity(core/shell)}, is represented by B.

(Structure 3) The core/shell type particle phosphor of Structure 1, wherein the particle diameter is 1-10 nm.

(Structure 4) The core/shell type particle phosphor of Structure 2, wherein the particle diameter is 1-10 nm.

After considerable effort during intensive studies to solve the above-described problems concerning a phosphor having submicron-nanostructure crystals, the inventors have found out that optimal nanostructure-crystals in which defects causing electron trapping are inhibited, in addition to high structural stability (durability), can be obtained by specifying the present invention range of a PL intensity ratio of a core particle phosphor to a core/shell type particle phosphor, when the core/shell type particle phosphor is formed by coating a shell portion composed of an inorganic component having a different composition onto the core phosphor prepared via the reactive crystallization method employed during preparation of a precursor, and a shell having high crystallinity and an even layer thickness together with an even composition is selected for a core particle having a sharp composition distribution accompanied with an even composition. It is found out that these are determined by the controlling electron-trapping energy level of the inside of a core, an interfacial state of a core and a shell, and the inside of a shell, and are also associated largely with the above-described ratio. Further, it is also found out that a particle phosphor having a particle diameter of at most 0.1 μm exhibits the same effect as that of a nano-size particle.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

Next, the present invention will be described in detail.

The reactive crystallization method is a method in which particles are produced by controlling a supersaturation degree while stirring two solutions which are to be reacted.

This reactive crystallization method is more useful than a method of manufacturing particles via other physical or chemical processes in view of energy conservation. Further, it is capable of acquiring a monodispersed particle distribution, and is an effective one among liquid phase methods to obtain high compositional homogeneity. As a specifically usable example of the reactive crystallization method, known is a method in which silver ions and halide ions are reacted in a reactor to produce silver halide particles which are poorly soluble salts, and the resulting silver halide particles are preferably usable as photosensitive particles in photographic industries and so forth.

When the particle phosphor (nanostructure crystals included) has an even intraparticle composition as well as an even interparticle composition, and particles are size-controlled so as to make fine particles by the reactive-crystallization method, the precursor having a particle diameter distribution exhibiting highly even monodispersity is obtained, whereby crystallization of core particles in a step of forming phosphor particles can be improved. Since particles were produced previously at a high supersaturation degree in the case of manufacturing poorly soluble salts such as silver halide and so forth, particles were excessively grown, and particle-to-particle coagulation was generated. Therefore, particles were usually monodispersed by using gelatin as a coagulation inhibitor. Similarly in the present invention, a dispersant as a coagulation inhibitor (for example, some kinds of surfactant, a protective colloidal agent, low molecular glycol and so forth) may be added, depending on an intended crystal composition.

The precursor particles produced by the reactive crystallization method have an average particle diameter (D₅₀) of at most 1 μm, but preferably an average particle diameter (D₅₀) of at most 0.1 μm, and more preferably an average particle diameter (D₅₀) of at most 0.03 μm. The primary particle (particles corresponding to precursors formed at the initial stage) state in addition to the dispersion state is preferred, but the coagulated secondary particle state may also be accepted, provided that the particle diameter is within the range of the present invention.

In order to produce the phosphor of the present invention, a step of baking the precursor obtained by the reactive crystallization method in a baking furnace and a step of spray-pyrolyzing a precursor solution can be conducted, but the spray-pyrolysis technique is preferable in order to prepare a particle phosphor of the present invention. The baking furnace technique includes a pulverizing treatment conducted by a ball mill method employing a built-up technique in order to obtain a phosphor having a desired particle diameter after a baking treatment, whereby high luminance can not be obtained because of large defects generated on the surface. On the other hand, the spray-pyrolysis technique applied in the present invention is preferably usable since spherical particles can be obtained with no pulverization.

Any means employed in a conventional pyrolysis method is usable in order to produce liquid droplets via spraying treatment. Examples thereof include a heat type atomizer, an ultrasonic atomizer, an oscillation type atomizer, a rotating-disc type atomizer, an electrostatic atomizer and a reduced-pressure type atomizer. The size of liquid droplets prepared by an atomizer and its distribution are utilized depending on the intended particles, since they affect the resulting primary particles as well as the particle size distribution.

A carrier gas such as air, nitrogen, helium, argon or hydrogen is employed for a drying/heating process of liquid droplets, which is conducted at an optimal flow rate in a stream passage within a heating furnace. The size, its distribution and crystallinity of intended particles in the present invention can be controlled by arranging to design the heating furnace so as to make a temperature-control function.

The phosphor of the present invention is effective with a core/shell type phosphor having a particle diameter of at most 0.1 μm, and is further effective with a core/shell type phosphor having a particle diameter of at most 10 nm (0.01 μm), exhibiting improved PL luminance and excellent light fastness. The lower limit of the particle diameter is not specifically limited, but it is not naturally zero. In addition, it is preferable that the phosphor of the present invention is effective with a core/shell type phosphor having a particle diameter of 1-100 nm, and it is more preferable that the phosphor of the present invention is effective with a core/shell type phosphor having a particle diameter of 1-10 nm.

PL described here is designated as emission luminance generated by stimulating light having a peak wavelength of 345 nm. A luminance ratio of a core particle singly to a core/shell particle is 0.001-0.1, but preferably 0.001-0.01. This has excellent effects in the present invention.

Inorganic phosphor compounds constituting the core portion, usable as phosphors of the present invention are specifically listed below, but the present invention is not limited thereto.

Examples of the following phosphors having a particle size of at most 10 nm, which exhibits a quantum effect include CdSe, CdTe, CdS, InP, InN, InGaP, InGaN, Si, Ge and ZnO. Phosphors other than the above-described are listed below.

### (Blue Light Emitting Phosphor Compounds)

Sr₂P₂O₇:Sn⁴⁺ (BL-1)

Sr₄Al₁₄O₂₅:Eu²⁺ (BL-2)

BaMgAl₁₀O₁₇:Eu²⁺ (BL-3)

SrGa₂S₄:Ce³⁺ (BL-4)

CaGa₂S₄:Ce³⁺ (BL-5)

(Ba,Sr) (Mg,Mn)Al₁₀O₁₇:Eu²⁺ (BL-6)

(Sr,Ca,Ba,Mg)₁₀(PO₄)6Cl₂:Eu²⁺ (BL-7)

ZnS:Ag (BL-8)

CaWO₄ (BL-9)

Y₂SiO₅:Ce (BL-10)

ZnS:Ag,Ga,Cl (BL-11)

Ca₂B₅O₉Cl:Eu²⁺ (BL-12)

BaMgAl₁₄O₂₃:Eu²⁺ (BL-13)

BaMgAl₁₀O₁₇:Eu²⁺,Tb³⁺,Sm²⁺ (BL-14)

BaMgAl₁₄O₂₃:Sm²⁺ (BL-15)

Ba₂Mg₂Al₁₂O₂₂:Eu²⁺ (BL-16)

Ba₂Mg₄Al₈O₁₈:Eu²⁺ (BL-17)

Ba₃Mg₅Al₁₈O₃₅:Eu²⁺ (BL-18)

(Ba, Sr, Ca) (Mg, Zn,Mn)Al₁₀O₁₇:Eu²⁺ (BL-19)

### (Green Light Emitting Phosphor Compounds)

(Ba,Mg)Al₁₆O₂₇:Eu²⁺,Mn²⁺ (GL-1)

Sr₄Al₁₄O₂₅:Eu²⁺ (GL-2)

(Sr,Ba)Al₂Si₂O₈:Eu²⁺ (GL-3)

(Ba,Mg)₂SiO₄:Eu²⁺ (GL-4)

Y₂SiO₅:Ce³⁺,Tb³⁺ (GL-5)

Sr₂P₂O₇—Sr₂B₂O₅:Eu²⁺ (GL-6)

(Ba,Ca,Mg)₅(PO₄)₃Cl:Eu²⁺ (GL-7)

Sr₂Si₃O₈-2SrCl₂:Eu²⁺ (GL-8)

Zr₂SiO₄,MgAl₁₁O₁₉:Ce³⁺, Tb³⁺ (GL-9)

Ba₂SiO₄:Eu²⁺ (GL-10)

ZnS:Cu,Al (GL-11)

(Zn,Cd)S:Cu,Al (GL-12)

ZnS:Cu,Au,Al (GL-13)

Zn₂SiO₄:Mn²⁺ (GL-14)

ZnS:Ag,Cu (GL-15)

(Zn,Cd)S:Cu (GL-16)

ZnS:Cu (GL-17)

Gd₂O₂S:Tb (GL-18)

La₂O₂S:Tb (GL-19)

Y₂SiO₅:Ce,Tb (GL-20)

Zn₂GeO₄:Mn (GL-21)

CeMgAl₁₁O₁₉:Tb (GL-22)

SrGa₂S₄:Eu²⁺ (GL-23)

ZnS:Cu,Co (GL-24)

MgO.nB₂O₃:Ce,Tb (GL-25)

LaOBr:Tb,Tm (GL-26)

La₂O₂S:Tb (GL-27)

SrGa₂S₄:Eu²⁺,Tb³⁺,Sm²⁺ (GL-28)

### (Red Light Emitting Phosphor Compounds)

Y₂O₂S:Eu³⁺ (RL-1)

(Ba,Mg)₂SiO₄:Eu³⁺ (RL-2)

Ca₂Y₈(SiO₄)₆O₂:Eu³⁺ (RL-3)

LiYg(SiO₄)₆O₂:Eu³⁺ (RL-4)

(Ba,Mg)Al₁₆O₂₇:Eu³⁺ (RL-5)

(Ba,Ca,Mg)₅(PO₄)₃Cl:Eu³⁺ (RL-6)

YVO₄:Eu³⁺ (RL-7)

YVO₄:Eu³⁺,Bi³⁺ (RL-8)

CaS:Eu³⁺ (RL-9)

Y₂O₃:Eu³⁺ (RL-10)

3.5MgO,0.5MgF₂GeO₂:Mn (RL-11)

YAlO₃:Eu³⁺ (RL-12)

YBO₃:Eu³⁺ (RL-13)

(Y,Gd)BO₃:Eu³⁺ (RL-14)

Silicate based phosphor compounds are listed below, but the present invention is not limited to these compounds.

### (Blue Light Emitting Inorganic Phosphor Compound)

Y₂SiO₅:Ce³⁺

### (Green Light Emitting Inorganic Phosphor Compounds)

(Ba,Mg)₂SiO₄:Eu²⁺

Y₂SiO₅:Ce³⁺,Tb³⁺

Sr₂Si₃O₈-2SrCl₂:Eu³⁺

Zr₂SiO₄,MgAl₁₁O₁₉:Ce³⁺,Tb³⁺

Ba₂SiO₄: Eu²⁺

Zn₂SiO₄:Mn²⁺

Y₂SiO₅:Ce³⁺, Tb³⁺

### (Red Light Emitting Inorganic Phosphor Compounds)

(Ba,Mg)₂SiO₄: Eu³⁺

Ca₂Y₈ (SiO₄)₆O₂:Eu³⁺

LiY₉(SiO₄)₆O₂:Eu³⁺

Silicon or a silicon compound are employed in the present invention, but the silicon compound herein means a solid containing silicon, and any solid containing silicon is usable, provided that it is substantially insoluble in an employed solution. Silica (silicon dioxide) and so forth, for example, are provided. Of these, silica is preferable. Examples of silica include vapor-deposited silica, precipitated silica, colloidal silica and so forth.

### (Step of Forming Precursor)

Next, a method of manufacturing the above-described phosphor of the present invention will be explained. The method for manufacturing a phosphor of the present invention comprises the steps of forming a phosphor precursor, acquiring phosphor particles in a core portion by baking the precursor prepared in the foregoing step of forming the precursor with a baking means, and forming a shell portion having a different composition from a core portion on the phosphor surface of the core portion. In addition, included may be a step of etching to remove impurities by etching the phosphor particle surface of the core portion before forming the shell portion.

The step of forming the precursor will be explained.

Any step may be employed as the step of forming a precursor of the present invention, but a step of synthesizing a precursor via a liquid phase method (referred to also as a liquid phase synthesis method) is specifically preferable. The precursor is an intermediate product of the phosphor, and the precursor is baked in the baking step at the prescribed temperature to obtain phosphor particles.

The liquid phase method is a method of synthesizing a precursor under the presence of a liquid, or in a liquid. In the liquid phase method, a reaction between element ions constituting a phosphor takes place, because phosphor materials are reacted in the liquid phase, and a highly pure phosphor can easily be obtained stoichiometrically. Further, in comparison to a solid phase method wherein reactions between solid phases as well as crushing steps are repeated to manufacture phosphors, the liquid phase method makes it possible to obtain particles each having a microscopic diameter without conducting a crushing step, and therefore, a lattice defect in a crystal caused by stress applied during crush can be avoided, and a decline of light-emission efficiency can be prevented.

In addition, as a liquid phase method in the present embodiments, usable are a conventional crystallization method typically known as cooling crystallization, and a sol-gel method, but a reactive crystallization method is specifically preferable.

A method of manufacturing an inorganic phosphor precursor via a sol-gel process means a method in which as an activator or a co-activator, some of the following are selected, where they are a metal alkoxide such as Si(OCH₃)₄ or EU³⁺(CH₃COCHCOCH₃)₃, a metal complex such as Mg[Al(OC₄H₉)₃]₂ prepared by introducing metallic magnesium into 2-butanol solution of Al (OC₄H₉)₃, double alkoxide prepared by introducing a single piece of metal into an organic solvent solution, a metal halide, and a metal salt of an organic acid or a single piece of meta, and a necessary amount of these is mixed to conduct polymerization thermally or chemically.

The method of manufacturing an inorganic phosphor precursor via the reactive crystallization method is a method of manufacturing the precursor by mixing solutions containing elements each representing a material of a phosphor or material gases in a liquid phase or the gaseous phase, by utilizing a crystallization phenomenon. The crystallization phenomenon in this case means a phenomenon that a solid phase is precipitated from a liquid phase when physical or chemical environmental changes caused by cooling, evaporation, pH adjustment and concentration are made, or when changes are made in the state of the mixing system by chemical reactions, while, in the reactive crystallizing method, it means a manufacturing method by means of physical operations and chemical operations caused by occurrence of the crystallization phenomenon of this kind.

Incidentally, for the solvent in the case of applying the reactive crystallization method, any solution can be employed provided that reaction materials are dissolved, and water is preferably usable in view of easy control to the supersaturation degree. When using plural reactive materials, they may be added either simultaneously or individually in terms of the addition order of materials, and it is possible to select appropriate order properly in accordance with activity.

In order to manufacture phosphors each being more microscopic in size and having a narrow particle size distribution, for preparation of precursors, it is preferable that material solution of two or more liquids is added directly into poor solvent in the presence of protective colloid. It is further preferable to adjust various physical characteristics such as a temperature during reaction, an addition speed, a stirring speed and pH, depending on a type of the phosphor, and a supersonic wave may be irradiated during reaction. It is further possible to add surfactants or polymers for controlling the particle size. In addition, at least one of concentration and ripening of the solution may be conducted as a preferable embodiment after completing the addition of materials, if desired.

A protective colloid is one to function for preventing aggregation of microscopic precursor particles, and various types of high polymer compounds may be used independently of natural and artificial ones, in which proteins among them can be used preferably.

As proteins, there are given, for example, gelatin, water-soluble protein and water-soluble glycoprotein. Specifically, there may be given albumin, ovalbumin, casein, soybean protein, synthesized protein and proteins synthesized on genetic engineering basis.

As gelatins, there are given, for example, lime-processed gelatin and oxygen-processed gelatin, and these can also be used in combination. In addition, hydrolysates of these gelatins and enzyme-decomposed products of these gelatins may be used.

A protective colloid does not need to be a single composition, and various binders may be mixed with the protective colloid. Specifically, for example, graft polymer of the above-described gelatin and other polymers can be used.

The protective colloid has preferably an average molecular weight of at least 10,000, more preferably an average molecular weight of 10,000-300,000, and most preferably an average molecular weight of 10,000-30,000. The protective colloid can be added into at least one material solution, and it may be added into all material solutions, and a particle diameter of a precursor can be controlled depending on an addition amount of the protective colloid and on an addition speed of a reaction solution.

Since various characteristics of the phosphor such as a particle diameter of a phosphor particle after baking, a particle diameter distribution and light emission characteristics are greatly influenced by properties of the precursor, it is preferable that the precursor is sufficiently made small by controlling a particle diameter of the precursor in the step of forming a precursor. If the precursor is made to be fine grains, coagulation of the precursor-to-precursor tends to be generated, and therefore, it is highly effective to synthesize the precursor after preventing the coagulation of precursor-to-precursor via addition of protective colloids, whereby a particle diameter is easily controlled. Incidentally, in the case of the reaction under existence of the protective colloids, it is desired to sufficiently consider the particle diameter distribution of the precursors and elimination of impurities such as accessory salt.

In the foregoing step of forming a precursor, a particle diameter is appropriately controlled as described above, and after synthesizing the precursors, they are collected by a method such as centrifugal separation and so forth, if desired, and then, washing and desalting steps may preferably be carried out.

The desalting step is a process to remove impurities such as accessory salt from the precursor, and various film separation methods, coagulating-sedimentation method, an electric dialysis method, a method to employ ion-exchange resins and a Nudel washing method may be used for the desalting step.

The desalting step may be conducted immediately after completing a step of forming a precursor. This step may also be conducted more than once, depending on the reaction situation of the material.

After the dehydration and desalting steps, a drying step may further be carried out. The drying step is preferably carried out after washing or desalting, and any of vacuum drying, air current drying, fluid bed drying and spray drying can be employed. A drying temperature among the foregoing is not particularly limited, and a preferable temperature is one that is equal to or higher than a temperature at which the solvent to be used is vaporized, and if the drying temperature is too high, drying and baking are simultaneously carried out, and a phosphor can be obtained with no succeeding baking process, thus, a range of 50-300° C. is preferable, and a range of 100-200° C. is more preferable.

### (Baking Step to Form Core Portion)

Next, a baking step will be explained. Each of phosphors of the present invention such as CdSe, InP, Si, a rare earth borate phosphor, a silicate phosphor and an aluminate phosphor can be prepared by baking each of corresponding phosphors. Conditions for the baking process (baking condition) will be explained here.

Any baking step is usable for a baking step, and baking temperature and baking time may be adjusted appropriately in the range of the present invention. For example, precursors are filled in an alumina boat, and baked at the prescribed temperature in the prescribed gas atmosphere to obtain a desired phosphor. Also usable is a spray baking method in which particle liquid droplets are formed employing an ultrasonic wave means and so forth to conduct a baking step in a carrier gas passage.

Any of commonly known baking furnaces (baking container) is usable. Preferable examples thereof include a box type furnace, a crucible furnace, a cylindrical tube type furnace, a boat type furnace, a rotary kiln and a spray baking furnace.

Further, a sinter-preventing agent may be added during baking, if desired. No addition may be given as a matter of course, in the case of no need of addition. In the case of adding a sinter-preventing agent, it may be added as slurry during precursor formation, or a powdery sinter-preventing agent may be mixed with dried precursors for baking.

The sinter-preventing agent is not particularly limited, and it is selected appropriately depending on a type of a phosphor and on baking conditions. For example, metal oxides such as TiO₂, SiO₂ and Al₂O₃ are preferably used for baking at temperatures of at most 800° C., at most 1000° C. and at most 1700° C., respectively. Accordingly, of these, Al₂O₃ is preferably usable.

Further, after a baking step, a reduction treatment or an oxidation treatment may be conducted, if desired. After the baking step, a cooling treatment, a surface treatment, a dispersion treatment or a classification treatment may be carried out.

The cooling treatment is a treatment process to cool baked products obtained through the baking step, and the cooling treatment makes it possible to cool the baked products while they remain filled in the foregoing baking furnace.

The cooling treatment is not particularly limited, but it can be selected appropriately from commonly known cooling methods. For example, usable is any of methods such as a method in which the temperatures is lowered by simply standing and a method in which a cooling device lowers the temperature compulsorily while controlling the temperature.

### (Dispersion Treatment)

Next, in the present invention, a dispersion treatment step will be described. Core phosphor particles obtained via the baking step may be subjected to a dispersion treatment.

As a dispersion treatment process, there are given, for example, an impeller type homogenizer of a high speed stirring type, an apparatuses such as a colloid mill, a roller mill, and a ball mill, a vibration ball mill, an attritor, a planetary mill and a sand mill, in which media are moved in an apparatus, and fine grains are produced by both of their collision and shearing force; and a dry type homogenizer such as a cutter mill, a hammer mill or a jet mill; or a ultrasonic homogenizer and a high pressure homogenizer.

Among these, it is preferable in the present invention to use a wet media type homogenizer particularly employing media, and it is more preferable to use a continuous and wet media type homogenizer that is capable of conducting a dispersion treatment continuously. It is further possible to utilize an embodiment in which a plurality of homogenizers of a continuous and wet media type are connected in series. The expression “capable of conducting a dispersion treatment continuously” mentioned in this case means an embodiment in which phosphors and dispersion media are supplied to a homogenizer at a constant ratio per unit time with no interruption for dispersing, and dispersed products manufactured in the homogenizer are ejected out of the homogenizer with no interruption, in a way that dispersed products are pushed out by a supply. When employing a wet and media type homogenizer employing media in the dispersion treatment step in a method of manufacturing a phosphor, a type of its container for dispersion chamber, namely, a type of a vessel can be appropriately selected from a vertical type and a horizontal type.

### (Etching Treatment)

Next, a surface treatment step via a etching treatment will be described.

Since the core phosphor of the present invention, unlike an electrolytic light-emission type phosphor has no role to improve light-emission intensity with projections on the surface, it is desired to conduct an etching treatment for a particle phosphor having less projections or no projections on the particle surface, and a particle phosphor having a large surface area per volume, in view of filling particle phosphors densely in a phosphor layer, and also in view of conducting an etching treatment evenly in order to reduce defects (electron trap and hole trap) generated on the particle phosphor surface.

In addition, the etching treatment can be selected depending on impurities on the phosphor particle surface. For example, a physical method to grind the surface with fine grains or ion sputtering may be used, but effective is a chemical method to dip phosphor particles in an etching solution to dissolve impurities on the surface.

In this case, however, the etching treatment is preferred to be carried out carefully, since light-emission intensity is lowered by corroding a phosphor particle main body with the etching solution.

A type of the usable etching solution is determined depending on impurities, and it may be either acid or alkaline, and it may also be either an aqueous solution or an organic solvent. In this case, when an acidic aqueous solution is employed, a remarkable effect is produced, and as a result, it is preferable particularly to use a strong acid. In addition, as a strong acid, a hydrochloric acid, a nitric acid, a sulfuric acid, a phosphoric acid and a perchloric acid can be employed, but a hydrochloric acid, a nitric acid and a sulfuric acid are preferable. Of these, a hydrochloric acid is more preferable.

After the etching treatment, a washing treatment and so forth may also be conducted to remove the etching solution.

### (Shell-Forming Step)

The core phosphor produced in the present invention is subjected to a coating treatment (shell formation) utilizing an inorganic composition which is different from the core portion composition. When a surface treatment is conducted depends on an intended target, and an appropriate selection of timing produces the prominent effect on the surface treatment. Accordingly, the surface treatment, for example, can be continuously carried out after conducting a step of baking the core portion, and also carried out after the baking step, and further a surface-etching treatment.

The shell portion composition is arbitrarily selected in conformity with the core portion composition. In the case of CdSe constituting a core portion, ZnS is selected as a shell composition, and ZnS can be formed on the CdSe surface via a chemical reaction of Zn with S by mixing core particles, a Zn compound and a S compound in a solvent under the appropriate temperature condition after forming the core CdSe. Also usable are a CDV method and a spray baking method in which a shell composition is sprayed toward core particles, and baked.

### EXAMPLE

Next, the present invention will be explained employing examples, but the present invention is not limited thereto.

### Examples

### <<Preparation of Phosphor>>

### <Preparation of Precursor (Reactive Crystallization Method)>

One thousand ml of water was first arranged to make A solution. Sodium metasilicate was dissolved in 500 ml of water in such a way that silicon had an ion concentration of 0.25 mol/l to make B solution. Zinc nitrate and manganese nitrate were dissolved in 500 ml of water in such a way that zinc had an ion concentration of 0.47 mol/l, and an activator (Mn) had an ion concentration of 0.03 mol/l to make C solution.

Solution A was introduced into a double jet reactive crystallization apparatus (reactor), which is an apparatus of manufacturing a phosphor as shown in FIG. 1, and the resulting was maintained at 40° C. to stir employing stirring blade 3R. In this situation, solutions A and B at 50° C. were introduced into solution A from nozzles 4R and 5R located at the bottom of the reactor at a constant addition speed of 50 ml/min while controlling the pH of the reaction solution. In this case, a stirring speed, the number of nozzles and a flow rate were changed to prepare a precursor. Stirring was conducted for 10 minutes while a temperature after the addition was decreased to 30° C. in order to stabilize the reaction system with any of precursors. The particle diameter of the resulting precursor particle was controlled by pH, a stirring speed and time, conforming to the particle diameter of the core particle prepared via a baking step carried out after this. Particles having a broad particle diameter distribution as shown in No. 9 (Comparative example 2) of Table 1 are also obtained by varying the above-described conditions.

After adjusting the precursor to viscosity so as to give spray liquid droplets, liquid droplets were formed by introducing this solution into an ultrasonic atomizer equipped with an oscillator of 1.7 MHz. Nitrogen gas containing 1% by volume of hydrogen gas was used as a carrier gas, and the foregoing liquid droplets were introduced into a tubular reactor produced by connecting a plurality of tubular heat reactors capable of controlling temperature in the range of 700-1300° C., and passed through a stream passage to obtain particle phosphor constituting a core. Ingenuity to classify liquid droplets at the starting point of liquid droplet introduction was taken, and temperatures at a middle point and at a stream passage end-point in the tube each were controlled to obtain each of core phosphors having a particle diameter and a particle diameter distribution as shown in Table 1.

### <Preparation of Comparative Core Phosphor (Solid Phase Method)>

As the raw material for a base material, zinc oxide (ZnO) and silicon dioxide (SiO₂) are mixed in a molar ratio of 2:1. Next, after an amount of manganese sesquioxide (Mn₂O₃) based on silicon dioxide and manganese sesquioxide in a molar ratio of 1:0.15 was added into this admixture, and mixed employing a ball mill, baking was conducted at 1250° C. under weak reductive atmosphere (N₂) for 2 hours. The resulting was pulverized with a wet ball mill to prepare each of intended atomized phosphors. The particle diameters and particle diameter distributions each are shown in Table 1.

### (Formation of Shell)

Sol particles obtained by dispersing particles of ZnS, ZnO and SiO₂ approximately in nanosize were sprayed onto the resulting core phosphor to obtain data as shown in Table 1. The spray liquid was mixed in midstream after preparation of the foregoing core particles, and the resulting was introduced and flowed into a tubular baking furnace to coat a shell composition onto the core surface. The shell composition and thickness are shown in Table 1.

### <<Evaluation of Phosphor>>

### <Measurement of Particle Diameter>

Core particle diameters of 200 particles were determined via TEM observation to obtain an average particle diameter.

### <Measurement of Shell Thickness>

The analysis of shell composition (Zn or Si) was made up to the depth to the core surface while etching with Ar ion employing an X-ray photoelectron spectroscopy apparatus (manufactured by Nitto Denko Corporation). The depth at which the shell composition reached 0% was determined as the shell thickness.

### <Measurement of Luminance>

### 1. PL Measurement

PL intensity was measured employing a fluorophotometer (FP777, manufactured by JASCO Corporation). PLE (photoluminescence excitation) was set to a wavelength of 345 nm to measure PL intensity,

The intensity ratio of the core particle to the shell particle is shown in Table 1.

Further, in order to detect PL luminance at the same level of PLE, it was measured employing a luminance meter (manufactured by Konica Minolta Sensing Inc.) The PL luminance values were described in relative value when PL luminance of Comparative example 1 was set to 100, as shown in Table 1.

### 2. CL Measurement

CL (cathode luminescence) intensity was measured employing Cathode Luminescence MP-32S/M (manufactured by Horiba, Ltd.). The intensity ratio of the core particle to the shell particle is also shown in Table 1.

### <Light Fastness>

The resulting phosphor was continued to be exposed to PLE (345 nm) employing a fluorophotometer (FP777, manufactured by JASCO Corporation) to measure the values of PL intensity after 5 minutes and 30 minutes, while recording the data. These values of intensity were described in relative value (%) when the intensity immediately before PLE exposure was set to 100 (%), as shown in Table 1.

TABLE 1

| | Core | | | | | | | | | | |
|---|---|---|---|---|---|---|---|---|---|---|---|
| | phosphor | | | | | | | | Light | Light | |
| | average | | | | | | | | fastness | fastness | |
| | particle | | | Shell | | | | | (%) | (%) | |
| Example | diameter | | Shell | thickness | | | | PL | after 5 | after 30 | |
| No. | (μm) | *1 | composition | (nm) | *2 | *3 | B/A | luminance | minutes | minutes | Remarks |
| 1 | 0.05 | 7 | ZnS | 20 | 0.04 | 0.4 | 10 | 600 | 100 | 100 | Inv. |
| 2 | 0.025 | 7 | ZnS | 7 | 0.01 | 0.2 | 20 | 1000 | 100 | 100 | Inv. |
| 3 | 0.01 | 7 | ZnS | 5 | 0.008 | 0.2 | 25 | 1200 | 100 | 100 | Inv. |
| 4 | 0.006 | 7 | ZnS | 3 | 0.002 | 0.2 | 100 | 2000 | 100 | 100 | Inv. |
| 5 | 0.01 | 5 | SiO₂ | 4 | 0.012 | 0.22 | 18 | 800 | 100 | 100 | Inv. |
| 6 | 0.01 | 10 | ZnS | 5 | 0.06 | 0.18 | 3 | 600 | 100 | 100 | Inv. |
| 7 | 0.006 | 5 | Zn0 | 3 | 0.009 | 0.01 | 11 | 1000 | 100 | 100 | Inv. |
| 8 | 0.01 | 7 | — | — | — | — | — | 100 | 70 | 50 | Comp. 1 |
| 9 | 0.01 | 7 | ZnS | 2 | 0.3 | 0.4 | 1.3 | 150 | 85 | 70 | Comp. 2 |
| 10 | 0.05 | 15 | ZnS | 20 | 0.3 | 0.4 | 1.3 | 160 | 85 | 70 | Comp. 3 |
| 11 | 0.05 | 35 | ZnS | 20 | 0.8 | 0.9 | 1.1 | 70 | 50 | 25 | Comp. 4** |
| 12 | 0.01 | 28 | ZnS | 5 | 0.85 | 0.9 | 1.1 | 50 | 50 | 20 | Comp. 5** |

*1: Core phosphor average particle diameter distribution (%)
Inv.: Inventive,
Comp.: Comparative example,
**(solid phase method)
*2: PL intensity ratio A of core particle to core/shell type particle
*3: CL intensity ratio B of core particle to core/shell type particle

As is clear from Table 1, it is to be understood in the present invention that a phosphor having a very small particle diameter exhibits excellent PL luminance together with excellent light fastness against continuous excitation. It is also to be understood that an effect of the present invention is produced when a value of B/A is arranged to be within the range of 10-100, where A is a PL intensity ratio, and B is a CL intensity ratio.

The above-described properties are useful in biological labeling and molecular imaging associated with a molecular biology field in which high detectability and accuracy for fluorescent-labeling fine organs in a cell, together with tracking of one molecule behavior, are demanded.

### [Effect of the Invention]

A core/shell type particle phosphor of the present invention exhibits an optimal excitation wavelength for fluorescence observation and excellent emission luminance of PL, together with excellent durability, to which particles are produced so as to be suitable for the field of bio-nanotechnology.

What is claimed is:

1. A core/shell type particle phosphor comprising a core particle phosphor and coated thereon, a shell made of a metal compound having a different composition from a composition constituting the core particle phosphor,
wherein the core particle phosphor is a particle phosphor prepared by baking a precursor synthesized via a reactive crystallization method, satisfying a PL (photoluminescence) intensity ratio A of the core particle phosphor to the core/shell type particle phosphor, {PL intensity(core)/PL intensity(core/shell)}; 0.001≦A≦0.1, and a core/shell type particle diameter of at most 0.1 μm.

2. The core/shell type particle phosphor of claim 1,
wherein a value of B/A is 10-100, provided that a CL (cathodeluminescence) intensity ratio of the core particle phosphor to the core/shell type particle phosphor, {CL intensity(core)/CL intensity(core/shell)}, is represented by B.

3. The core/shell type particle phosphor of claim 1,
wherein the particle diameter is 1-10 nm.

4. The core/shell type particle phosphor of claim 2,
wherein the particle diameter is 1-10 nm.
